(19) United States
(12) Patent Application Publication
(10) Pub. No.: US 2012/0059719 A1
(43) Pub. Date: Mar. 8, 2012

(54) ADVERTISEMENT DISTRIBUTION SERVER AND ADVERTISEMENT DISTRIBUTION METHOD

(75) Inventor: Yukinao Ajima, Tokyo (JP)

(73) Assignee: For-side.com Co., Ltd., Tokyo (JP)

(21) Appl. No.: 13/145,411

(22) PCT Filed: Jul. 1, 2010
(86) PCT No.: PCT/JP10/61276

§ 371 Date: Jul. 20, 2011

(51) Int. Cl. G06Q 30/02

(52) U.S. Cl. 705/14.58

(57) ABSTRACT

An advertisement distribution server 10 is connected through a communication network N to a user terminal 1 including an application program capable of displaying advertisement information, and distributes the advertisement information to the user terminal 1. The advertisement distribution server 10 includes a CPU 11 and a DB 20 that stores advertisement information 23. The CPU 11 decides whether or not an advertisement is distributable to the user terminal 1 based on a UA obtained from the user terminal 1 or on user position information capable of specifying an access area of the user terminal 1 when an application program of the user terminal 1 is activated; decides the advertisement information 23, which is to be distributed from the DB 20 to the user terminal 1, based on a predetermined condition in a case where it is decided that the advertisement is distributable; and distributes the advertisement information 23 to the user terminal in a case where the advertisement information 23 to be distributed is decided. In such a way, advertisement distribution more accurate for a user can be performed without changing the application program.

### CROSS REFERENCE TO RELATED APPLICATION

This application is entitled to the benefit of and incorporates by reference essential subject matter disclosed in International Patent Application No. PCT/JP2010/061276 filed on Jul. 1, 2010.

### TECHNICAL FIELD

The present invention relates to an advertisement distribution server and an advertisement distribution method.

### BACKGROUND OF THE INVENTION

In recent years, a technique has been known, in which preset advertisement information is displayed on a display screen when an application program such as an image viewer is activated (for example, refer to Japanese Patent Application Laid-Open Publication No. 2002-230392).

When contents are provided to a user, such advertisement information is incorporated into information of the contents, and is distributed.

### SUMMARY OF THE INVENTION

However, in the above-described application program, in terms of characteristics thereof, there has been a problem that once the program concerned is constructed, it is necessary to reconstruct the program in order to change the advertisement information incorporated thereinto, resulting in complications.

Moreover, even in an application program with the same design, an advertisement regulation differs depending on a type of a user terminal for use, and accordingly, there has been a problem that an individual application program is required in order to perform advertisement distribution corresponding to the type of the user terminal.

Furthermore, there has also been a problem that the application program cannot deal with the actual circumstances that the advertisement information to be distributed differs depending on an area owing to the globalization.

It is an object of the present invention to provide an advertisement distribution server and an advertisement distribution method, which are capable of advertisement distribution more accurate for the user without changing the application program.

In order to solve the above described problems, according to the invention, provided is an advertisement distribution server which distributes advertisement information to a user terminal including an application program capable of displaying the advertisement information, the advertisement distribution server being connected to the user terminal through a communication network, wherein the advertisement distribution server comprises:

an advertisement information database to store the advertisement information;

an advertisement distribution feasibility deciding unit to decide whether or not an advertisement is distributable to the user terminal, based on a user agent obtained from the user terminal or on user position information capable of specifying an access area of the user terminal, when the application program of the user terminal is activated;

a distribution advertisement deciding unit to decide the advertisement information to be distributed from the advertisement information database to the user terminal, based on a predetermined condition, in a case where the advertisement is decided to be distributable by the advertisement distribution feasibility deciding unit; and

a distributing unit to distribute the advertisement information to the user terminal, in a case where the advertisement information to be distributed is decided by the distribution advertisement deciding unit.

Further, according to the invention, provided is an advertisement distribution server, wherein an advertisement distribution feasibility deciding unit includes:

a carrier specifying unit to obtain the user agent from the user terminal when the application program of the user terminal is activated, so as to specify a carrier of the user terminal;

a first feasibility deciding unit to decide whether or not the advertisement is distributable, based on the carrier specified by the carrier specifying unit;

an identifying unit to identify the access area of the user terminal, based on a global internet protocol (IP) address as the user position information, in a case where the user agent cannot be obtained or the carrier cannot be specified by the carrier specifying unit; and

a second feasibility deciding unit to decide whether or not the advertisement is distributable, based on the access area identified by the identifying unit.

Further, according to the invention, provided is an advertisement distribution server, wherein an application program is an electronic book viewer.

Further, according to the invention, provided is an advertisement distribution server, wherein an advertisement distribution server further comprises:

a book information database to store book information, wherein

the distribution advertisement deciding unit decides the advertisement information to be distributed from the advertisement information database to the user terminal, based on the predetermined condition, in a case where a search request is made to the book information database by the user terminal during an operation of the application program of the user terminal.

Further, according to the invention, provided is an advertisement distribution server, wherein in a case where book information corresponding to a keyword specified by the user terminal is searched from the book information database, a distribution advertisement deciding unit decides the advertisement information to be distributed from the advertisement information database to the user terminal, so that priority is given to advertisement information including the keyword, as the predetermined condition.

Further, according to the invention, provided is an advertisement distribution method to distribute advertisement information from the advertisement distribution server to the user terminal including the application program capable of displaying the advertisement information, the advertisement distribution server being connected to the user terminal through the communication network, wherein an advertisement distribution method comprises:

an advertisement distribution feasibility deciding step of deciding whether or not the advertisement is distributable to the user terminal, based on the user agent obtained from the user terminal or on the user position information capable of specifying the access area of the user terminal, when the application program of the user terminal is activated;

a distribution advertisement deciding step of deciding the advertisement information to be distributed from the advertisement information database to the user terminal, based on the predetermined condition, in the case where the advertisement is decided to be distributable in the advertisement distribution feasibility deciding step; and

a distributing step of distributing the advertisement information to the user terminal, in the case where the advertisement information to be distributed is decided in the distribution advertisement deciding step.

Further, according to the invention, provided is an advertisement distribution method, wherein an advertisement distribution feasibility deciding step includes:

a carrier specifying step of obtaining the user agent from the user terminal when the application program of the user terminal is activated, and of specifying the carrier of the user terminal;

a first feasibility deciding step of deciding whether or not the advertisement is distributable, based on the carrier specified in the carrier specifying step;

an identifying step of identifying the access area of the user terminal, based on the global IP address as the user position information, in the case where the user agent cannot be obtained or the carrier cannot be specified in the carrier specifying step; and

a second feasibility deciding step of deciding whether or not the advertisement is distributable, based on the access area identified in the identifying step.

Further, according to the invention, provided is an advertisement distribution method, wherein an advertisement distribution method further comprises:

a second distribution advertisement deciding step of deciding the advertisement information to be distributed from the advertisement information database to the user terminal, based on the predetermined condition, in the case where the search request for the keyword is made by the user terminal during the operation of the application program of the user terminal.

Further, according to the invention, provided is an advertisement distribution method, wherein an advertisement distribution method further comprises:

a third distribution advertisement deciding step of deciding the advertisement information to be distributed from the advertisement information database to the user terminal, so that priority is given to the advertisement information including the keyword specified by the user terminal, as the predetermined condition, in the case where the book information corresponding to the keyword is searched from the book information database.

In accordance with the present invention, on the advertisement distribution server side, it is decided whether or not the advertisement is distributable to the user terminal based on the user agent or on the user position information capable of specifying the access area of the user terminal, and accordingly, appropriate advertisement distribution corresponding to the carrier and area of the user terminal can be performed.

Moreover, in the case where it is decided that the advertisement is distributable, the advertisement information to be distributed is decided from the advertisement information database based on the predetermined condition, and accordingly, the optimal advertisement information can be obtained from among the advertisement information in the advertisement information database, and can be then distributed.

In such a way, even if the application program is not particularly changed on the user terminal side, the advertisement distribution more accurate for the user can be performed.

### BRIEF DESCRIPTION OF THE DRAWINGS

FIG. 1 illustrates a system configuration diagram for explaining a relationship between an advertisement distribution server of the present invention and user terminals.

FIG. 2 is a conceptual diagram for explaining a configuration of a database of the advertisement distribution server.

FIG. 3 is a block diagram for explaining a configuration of the user terminal.

FIG. 4 is an example of an activation screen.

FIG. 5 is an example of a front cover screen of a book.

FIG. 6 is an example of a book body screen.

FIG. 7 is a view for explaining an example of an operation for the book body screen.

FIG. 8 is a view showing a state where an additional operation menu button group is displayed on the book body screen.

FIG. 9 is an example of a link destination screen.

FIG. 10 is an example of a search screen.

FIG. 11 is an example of a search result screen.

FIG. 12 is an example showing advertisement information in an image banner format.

FIG. 13 is an example showing advertisement information in a text link format.

FIG. 14 is a flowchart showing advertisement distribution processing at a time when the user terminal is activated.

FIG. 15 is a flowchart showing advertisement distribution feasibility deciding processing in FIG. 14.

FIG. 16 is a flowchart showing advertisement distribution processing at a time when the user terminal is operated.

### DETAILED DESCRIPTION OF THE PREFERRED EMBODIMENTS

A description is given hereinbelow in detail of an embodiment of the present invention with reference to the drawings. However, the scope of the invention is not limited to the illustrated example.

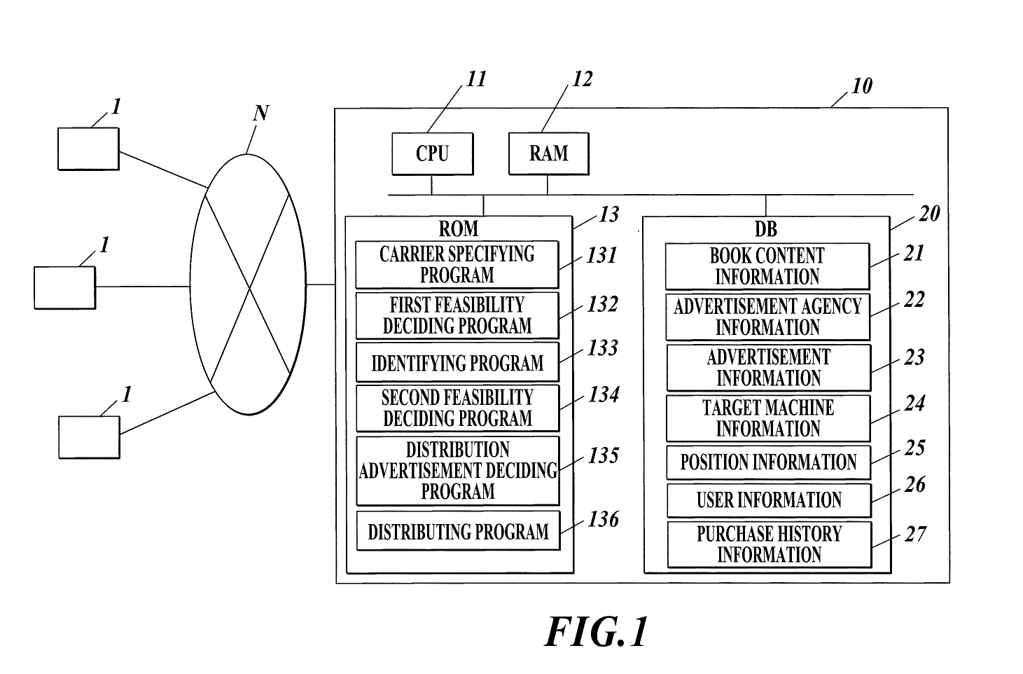

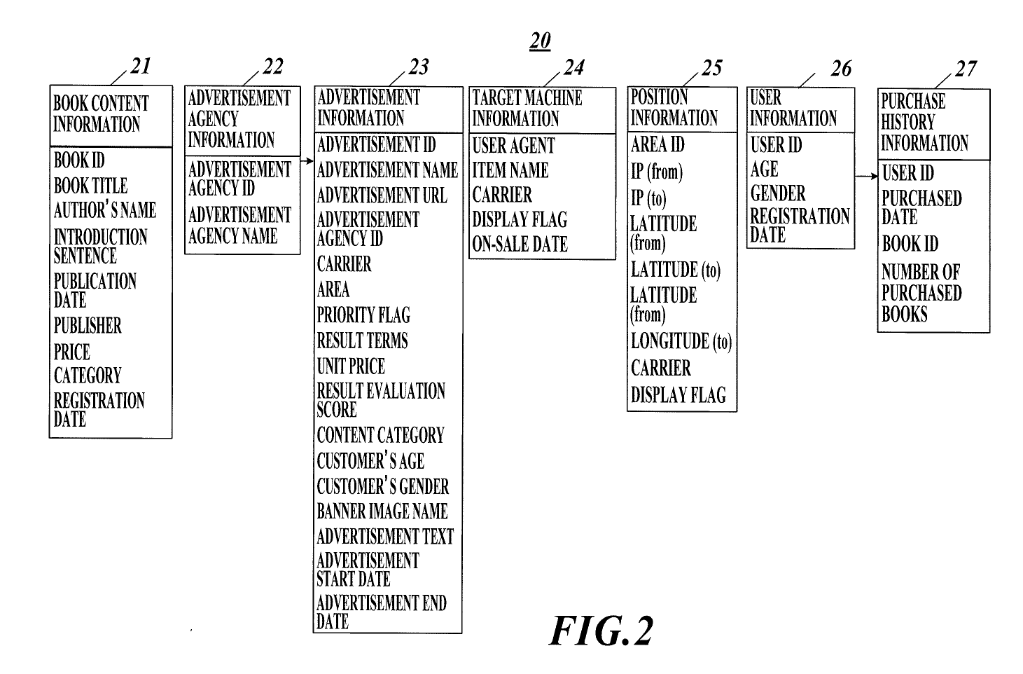

As shown in FIGS. 1 and 2, an advertisement distribution server 10 is connected through a communication network N to user terminals 1 owned by users (that is, advertisement recipients).

### (User Terminal)

Each of the user terminals 1 is, for example, an electronic book device including an electronic book viewer 41 as an application program.

Here, the electronic book device is a device that obtains book data (book information) in which contents of a book are converted into digital data, displays the obtained book data, and enables the contents of the book to be browsed.

Note that the book data is contents created in a text data format or in a data format in which composition information is added to text, and is formatted and displayed after being transferred to the viewer.

The user can obtain desired book data by accessing the advertisement distribution server 10 by using the user terminal 1 as described above. At this time, the advertisement distribution server 10 distributes advertisement information displayable on the electronic book viewer 41.

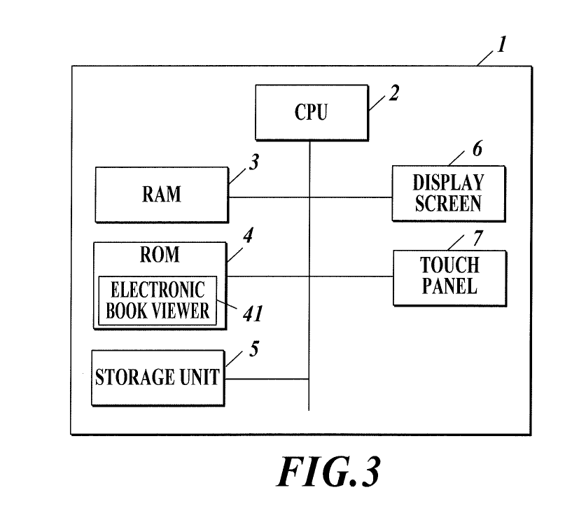

Specifically, for example as shown in FIG. 3, the user terminal 1 is composed by including: a central processing unit (CPU) 2; a random access memory (RAM) 3; a read only memory (ROM) 4; a storage unit 5; a display screen 6; a touch panel 7; and the like.

The CPU 2 reads out application programs such as the electronic book viewer 41 stored in the ROM 4 when necessary, expands the read out application program in the RAM 3, followed by execution thereof, and thereby switches display of the display screen 6, for example, in response to an operation to the touch panel 7.

The storage unit 5 is composed of a large-capacity flash memory or the like, and stores the book data and the like.

The display screen 6 is composed of a liquid crystal display (LCD) or the like, and displays images of the book data and the like.

The touch panel 7 is arranged on the display screen 6.

For the touch panel 7, for example, a full screen touch panel referred to as “multi-touch” may be adopted.

Unlike a general touch panel, the full screen touch panel can recognize a speed and direction in which the screen is patted besides a touch to the screen, and enables operations such as a tap (operation of lightly tapping the screen once by the finger) equivalent to a click of a mouse, a double tap (operation of tapping the screen twice by the finger) equivalent to a double click of the mouse, a drag (operation of moving display contents by shifting the finger), a flick (operation of scrolling the screen by lightly flicking the screen by the finger), a pinch out (operation of enlarging the display by opening two fingers apart from each other), and a pinch in (operation of reducing the display by closing two fingers).

Moreover, longitudinal and lateral directions of the display can be sensed by an acceleration sensor (not shown) built in the viewer, and a display direction of the display screen 6 can also be switched depending on a way of holding the viewer (longitudinal holding, lateral holding).

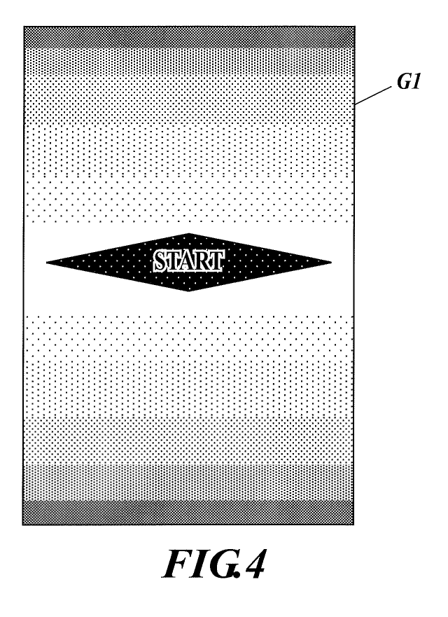

Here, FIGS. 4 to 13 show screen examples displayed on the display screen 6 of the user terminal 1.

FIG. 4 is an example of an activation screen G1 of the user terminal 1. When the user activates the electronic book viewer 41 in the user terminal 1, this activation screen G1 is displayed on the display screen 6.

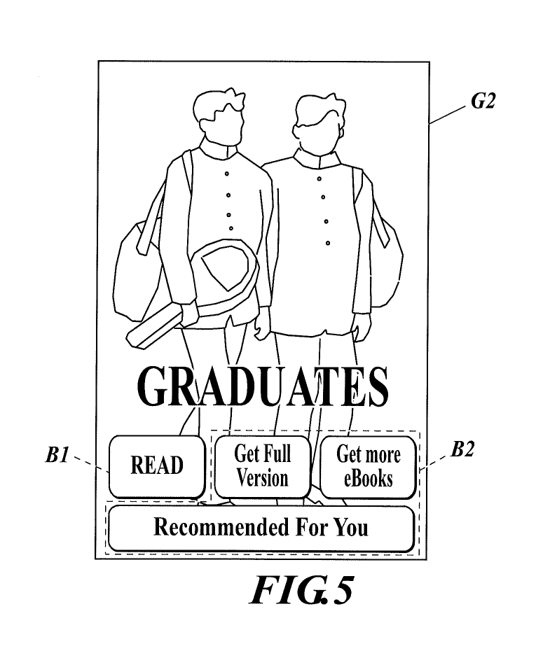

FIG. 5 is an example of a front cover screen G2 of the book. This front cover screen G2 of the book is displayed on the display screen 6 immediately after the user performs an operation to decide the book to be read in the event of reading the book.

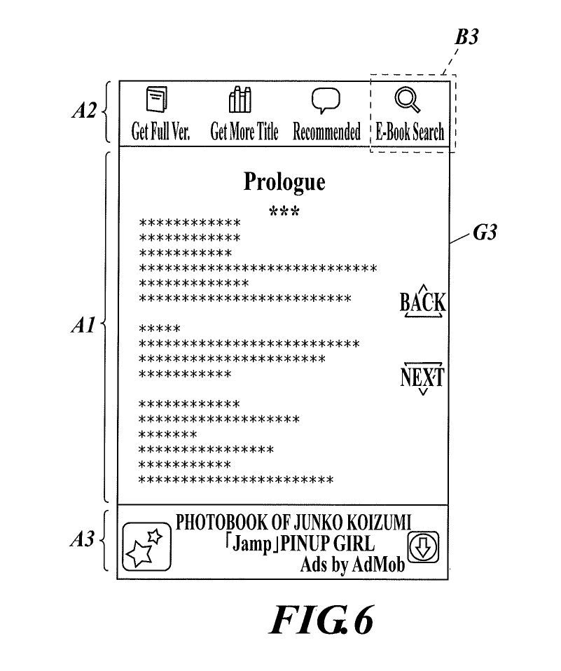

On a lower portion of the display screen G2, a reading start button B1, an operation menu button group B2 and the like are arranged. The reading start button B1 is operated when the user starts to read (read a book body), and when the reading start button B1 is operated, a book body screen G3 (refer to FIG. 6) is displayed on the display screen 6.

FIG. 6 is an example of a book body screen G3.

The book body screen G3 includes: a body text display portion Al arranged at a center, on which letters (sentences) as the book body are displayed; an operation menu display portion A2 arranged thereabove; and an advertisement display portion A3 arranged thereunder.

On the body text display portion A1, sentences equivalent to one page of a usual book are displayed in horizontal writing or vertical writing, and a BACK button and a NEXT button for moving the sentences forward and backward are provided.

On the operation menu display portion A2, a full text obtaining button (Get Full Ver.), an another book obtaining button (Get More Title), a recommended information display button (Recommended) and the like are displayed besides a search button (E Book Search) B3.

On the advertisement display portion A3, the advertisement information distributed from the advertisement distribution server 10 is displayed as a banner advertisement.

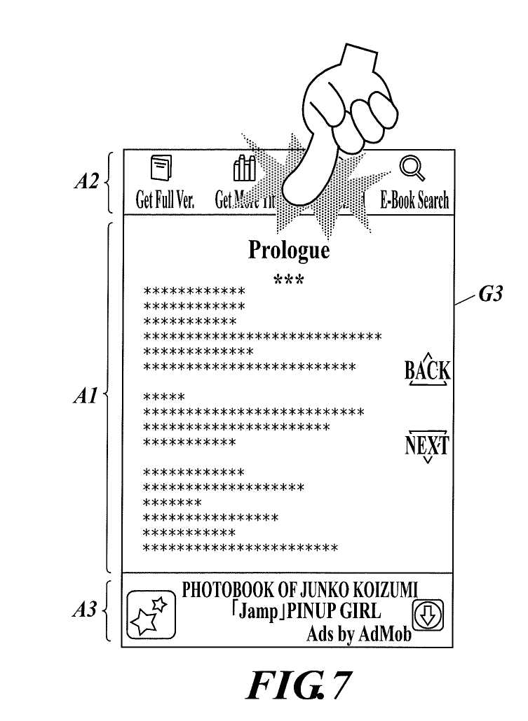

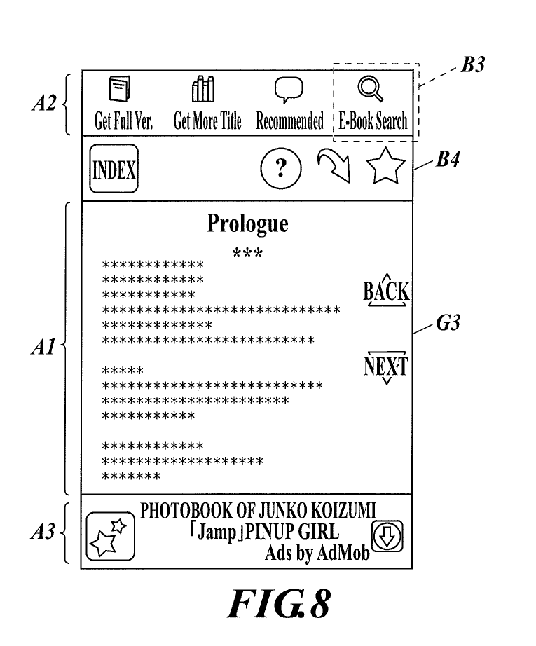

Here, as shown in FIG. 7, when an upper portion of the book body screen G3 is tapped by the finger, then as shown in FIG. 8, an additional operation menu button group B4 appears, and when the upper portion of the book body screen G3 is tapped by the finger one more time, this operation menu button group B4 disappears. That is to say, display of the operation menu button group B4 can be arbitrarily changed.

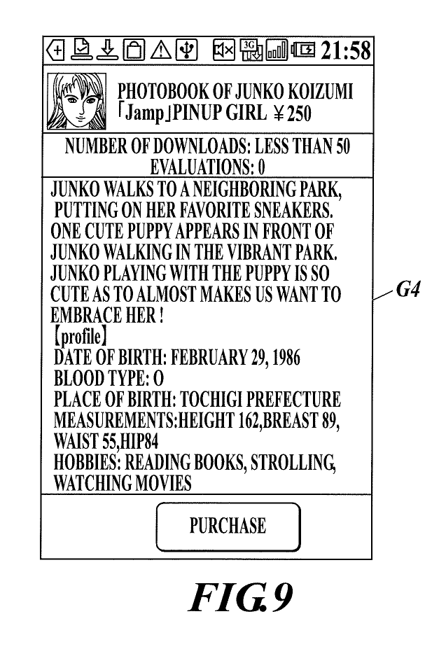

Moreover, when the advertisement display portion A3 is tapped by the finger, then as shown in FIG. 9, a transition is made from the book body screen G3 to a link destination screen G4 as a link destination specified by the advertisement information displayed on the advertisement display portion A3.

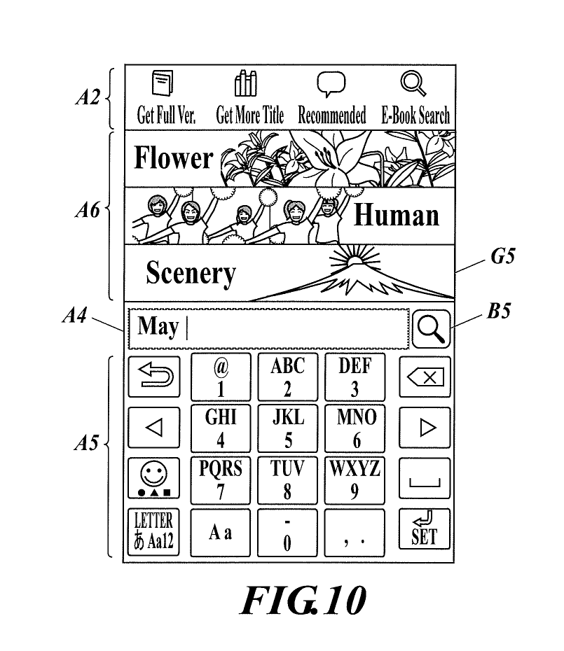

Furthermore, when the search button B3 of the operation menu display portion A2 shown in FIG. 6 is operated, then a search screen G5 (refer to FIG. 10) is displayed on the display screen 6.

FIG. 10 is an example of the search screen G5.

The search screen G5 includes: a search bar A4; an input portion A5 for allowing the user to input letters to the search bar A4; and an advertisement display portion A6. Moreover, in an upper portion with respect to the search screen G5, the operation menu display portion A2 is displayed.

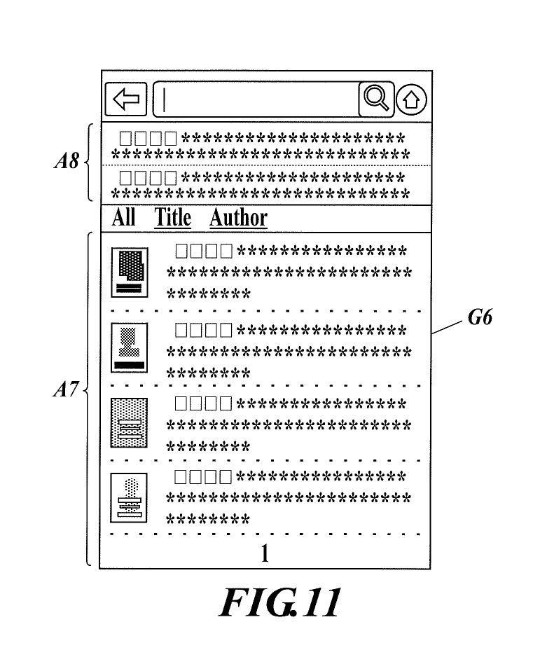

A keyword is inputted to the search bar A4 in response to an operation of the user to the input portion A5. Next to the search bar A4, a start button B5 for instructing the user terminal to execute a search is provided, and when the start button B5 is operated after the input of the keyword, then the search is executed, and as a result, a search result screen G6 (refer to FIG. 11) is displayed on the display screen 6.

The input portion A5 includes a key group for specifying varieties of letters and numbers, arrows, symbols and the like, and when the user inputs the keyword by the input portion A5, the keyword concerned is displayed on the search bar A4.

On the advertisement display portion A6, advertisement information distributed from the advertisement distribution server 10 is displayed as banner advertisements.

Note that, though FIG. 10 is an example in which three pieces of advertisement information, which are different from one another, are displayed on the advertisement display portion A6, the number of pieces of the advertisement information to be displayed is arbitrarily settable.

FIG. 11 is an example of the search result screen G6.

The search result screen G6 includes: a book list display portion A7 that displays a book list obtained by searching book content information 21 (to be described later) of a DB 20 by using the keyword inputted on the above-described search screen G5; and an advertisement display portion A8.

On the book list display portion A7, book information including the keyword is displayed as a list.

On the advertisement display portion A8, advertisement information distributed from the advertisement distribution server 10 is displayed as a list.

Note that, though FIG. 11 is an example in which two pieces of advertisement information, which are different from each other, are displayed on the advertisement display portion A6, the number of pieces of the advertisement information to be displayed is arbitrarily settable.

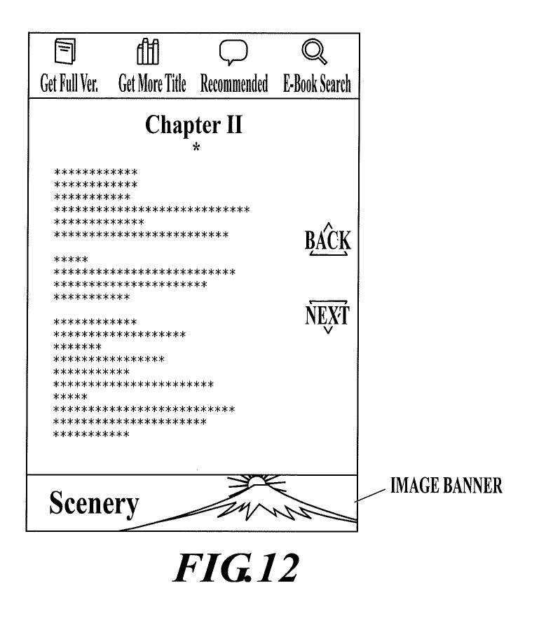

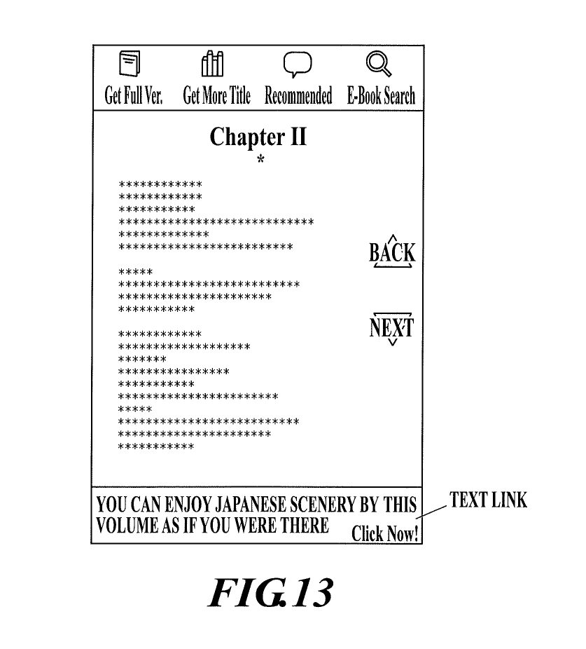

Note that the advertisement information to be displayed on the advertisement display portion A3 of the book body screen G3 and on the advertisement display portion A6 of the search screen G5 may be, for example, either in the image banner format as shown in FIG. 12 or in the text link format as shown in FIG. 13.

Note that, in the case of the advertisement information in the text link format, frame dimensions of the advertisement display portions A3 and A6 are automatically obtained, and the advertisement information is displayed in a format in which letters are streaming.

### (Advertisement Distribution Server)

As shown in FIG. 1, the advertisement distribution server 10 includes: a CPU 11; a RAM 12; a ROM 13; the database (DB) 20; and the like, and is connected to the communication network N through a communication interface (not shown).

Here, a description is given for a configuration of the DB 20.

In the DB 20, there are stored: book content information 21; advertisement agency information 22; advertisement information 23; target machine information 24; position information 25; user information 26; purchase history information 27; and the like.

The book content information 21 is the book data (book information) distributable to the users.

The book content information 21 is composed by including book IDs, book titles, author's names, introduction sentences, publication dates, publishers, prices, categories, registration dates and the like.

Note that the DB 20 functions as a book information database by storing the book content information 21.

The advertisement agency information 22 is information on advertisement agencies. Here, the advertisement agencies stand for entities, who submit the advertisement information to the advertisement distribution server 10, as agencies for one or plural advertisers who pay advertisement fees and submit advertisements.

The advertisement agency information 22 is composed by including advertisement agency IDs, advertisement agency names and the like. This advertisement agency information 22 is associated with the advertisement information 23 through the advertisement agency IDs.

The advertisement information 23 is advertisement information submitted from the plurality of advertisement agencies.

The advertisement information 23 is composed by including advertisement IDs, advertisement names, advertisement URLs, the advertisement agency IDs, carriers, areas, priority flags, result terms, unit prices, result evaluation scores, content categories, customers' ages, customers' gender, banner image names, advertisement text, advertisement start dates, advertisement end dates, and the like.

Note that the DB 20 functions as an advertisement information database by storing the advertisement information 23.

The target machine information 24 is composed by including user agents (UAs), item names, carriers, display flags, on-sale dates and the like.

In the UAs, unique letter strings are included, which indicate the carriers (for example, mobile communication carriers, internet service providers (ISPs) and the like) as communication carriers which provide communication network environments to the respective user terminals.

Therefore, each of the carriers is associated with each of the plurality of UAs. For the respective carriers, the display flags, which indicate “advertisement is distributable” or “advertisement is indistributable”, are set.

Hence, the target machine information 24 is usable for deciding whether the carriers of the user terminals 1 are advertisement-distributable carriers or advertisement-indistributable carriers.

That is to say, in the case where the UAs are obtained, the carriers are specified by this target machine information 24, and by the display flags of the carriers, it is determined whether the carriers concerned are the advertisement-distributable carriers or the advertisement-indistributable carriers.

The position information 25 is composed by including area IDs, IPs (from), IPs (to), latitudes (from), latitudes (to), longitudes (from), longitudes (to), carriers, display flags, and the like.

Each of the area IDs is assigned, for example, to each country.

Then, the IP (from), the IP (to), the latitude (from), the latitude (to), the longitude (from) and the longitude (to) are associated with each of the plurality of area IDs.

Moreover, one or plural carriers which correspond to each of the plurality of area IDs are assigned to the area ID concerned, and further, the display flags, which indicate “advertisement is distributable” or “advertisement is indistributable”, are set for the respective carriers.

Hence, the position information 25 is usable for deciding, from global IP addresses (user position information), whether the user terminals 1 are located in areas in which the advertisement-distributable carriers are included or located in areas in which the advertisement-indistributable carriers are not included.

That is to say, the area IDs are decided by the global IP addresses, and by the carriers and the display flags, which correspond to the area IDs, it is determined whether the area IDs are of the areas in which the advertisement-distributable carriers are included or of the areas in which the advertisement-indistributable carriers are not included.

The user information 26 is information stored in the DB 20 by registration work performed in advance by the users.

The user information 26 is composed by including IDs, ages and gender of the users, registration dates, and the like.

Moreover, the user information 26 is associated with the purchase history information 27 through the user IDs.

The purchase history information 27 is information on purchase histories for each of the users, and is updated every time each of the users purchases a book. The purchase history information 27 is composed by including the user IDs, purchase dates, the book IDs, the number of purchased books, and the like.

The CPU 11 performs various pieces of control processing, for example, in accordance with a variety of processing programs stored in the ROM 13.

The RAM 12 forms a work memory area that stores data subjected to operation processing by the CPU 11.

For example, the ROM 13 stores: a system program executable by the CPU 11; a variety of processing programs executable by the system program concerned; data for use at the time of executing these various processing programs; data of a variety of processing results subjected to the operation processing of the CPU 11; and the like. Note that the programs are stored in the ROM 13 in a form of a program code readable by a computer.

Specifically, in the ROM 13, there are stored: a carrier specifying program 131; a first feasibility deciding program 132; an identifying program 133; a second feasibility deciding program 134; a distribution advertisement deciding program 135; a distributing program 136; and the like.

The carrier specifying program 131 is a program for allowing the CPU 11 to realize a function to obtain the user agent (UA) from each of the user terminals 1, for example, at the time when the application program of the user terminal 1 is activated, and to specify the carrier of the user terminal 1 concerned.

Specifically, upon obtaining the UA when the user terminal 1 is activated, the CPU 11 specifies the carrier, which corresponds to the UA, based on the above-described target machine information 24 of the DM 20.

Note that, in the case where the carrier is specified from the UA, the information on the specified carrier is held by the RAM 12 while the electronic book viewer 41 of the user terminal 1 is being activated.

The CPU 11 executes such a carrier specifying program 131, and thereby functions as a carrier specifying unit.

The first feasibility deciding program 132 is a program for allowing the CPU 11 to realize a function to decide whether or not the advertisement is distributable, for example, based on the carrier specified by executing the carrier specifying program 131.

Specifically, upon specifying the carrier, the CPU 11 decides whether or not the advertisement is distributable to the specified carrier based on the above-described target machine information 24 of the DM 20.

For example, the carrier concerned is the advertisement-distributable carrier if the display flag is “advertisement is distributable”, and is the advertisement-indistributable carrier if the display flag is “advertisement is indistributable.

The CPU 11 executes such a first feasibility deciding program, and thereby functions as a first feasibility deciding unit.

The identifying program 133 is a program for allowing the CPU 11 to realize a function to identify an access area of the user terminal 1 by the global IP address as the user position information, for example, in the case where it is impossible to obtain the UA or specify the carrier by executing the carrier specifying program 131.

Specifically, in the case where it is impossible to obtain the UA or specify the carrier, the CPU 11 collates the global IP address of the user terminal 1 with the position information 25 of the DM 20, recognizes an area ID applicable to the user terminal 1, and thereby identifies the access area of the user terminal 1.

Note that, once obtained, the global IP address of the user terminal 1 is held by the RAM 12 while the electronic book viewer 41 of the user terminal 1 is being activated.

The CPU 11 executes such an identifying program, and thereby functions as an identifying unit.

The second feasibility deciding program 134 is a program for allowing the CPU 11 to realize a function to decide whether or not the advertisement is distributable, for example, based on the access area identified by executing the identifying program 133.

Specifically, the CPU 11 refers to the carrier and the display flag in the position information 25 of the DM 20, which correspond to the area ID applicable to the user terminal 1, and determines whether the area ID concerned is of the area in which the advertisement-distributable carrier is included or of the area in which the advertisement-indistributable carrier is not included.

For example, in the case where there is a carrier in which the display flag indicating “advertisement is indistributable” is set for the area ID, it is decided not to distribute the advertisement thereto, and in the case where there is not a carrier in which the display flag indicating “advertisement is indistributable” is set for the area ID, it is decided to distribute the advertisement thereto.

The CPU 11 executes such a second feasibility deciding program, and thereby functions as a second feasibility deciding unit.

Hence, the CPU 11 executes the above-described carrier specifying program 131, first feasibility deciding program 132, identifying program 133 and second feasibility deciding program 134, and thereby composes an advertisement distribution feasibility deciding unit, and when the application program of the user terminal 1 is activated, the CPU 11 decides whether or not the advertisement is distributable to the user terminal 1 based on the UA or the global IP address, which are obtained from the user terminal 1 concerned.

The distribution advertisement deciding program 135 is a program for allowing the CPU 11 to realize a function to decide the advertisement information 23, which is to be distributed from the DB 20 to the user terminal 1, based on a predetermined condition, for example, in the case where it is decided that the advertisement is distributable by the advertisement distribution feasibility deciding unit.

Specifically, in the case where it is decided that the advertisement is distributable by the above-described advertisement distribution feasibility deciding unit at the time when the user terminal 1 is activated, the CPU 11 executes the distribution advertisement deciding program 135.

Then, the CPU 11 searches, advertisement information that enables advertisement display on the user terminal 1 concerned from the DB 20, and decides, as advertisement information to be distributed, optimal advertisement information based on the predetermined condition from thereamong.

Here, the predetermined condition is a condition for narrowing down the advertisement information 23 by contents thereof (for example, the priority flag, the result evaluation score, the content category, the customer's age, the customer's gender and the like).

Specifically, for example, the advertisement information 23 is narrowed down in an order such as, firstly by one in which the higher priority flag is set, secondly by one in which the result evaluation score is high, thirdly by one in which the content category is the same as a category of the book content information 21 to be displayed, fourth by one in which the customers' age is the same as an age in the user information 26, and fifth by one in which the customers' gender is the same as gender in the user information 26.

Note that the advertisement information decided as described above as the advertisement information, which is to be distributed, by executing the distribution advertisement deciding program 135 at the time when the user terminal 1 is activated is displayed, for example, on the advertisement display portion A3 of the book body screen G3 (refer to FIG. 6).

Moreover, also in the case where a search request is made to the DB 20 (book information database) during the operation of the application program of the user terminal 1 (that is to say, in the case where the search button B3 is operated during the display of the book body screen G3 (refer to FIG. 6)), the CPU 11 executes the distribution advertisement deciding program 135, and decides, as the advertisement information to be distributed, the optimal advertisement information based on a predetermined condition.

In this case, the predetermined condition is the same as the condition in the distribution advertisement deciding processing at the time when the user terminal 1 is activated.

Note that the advertisement information decided as described above as the advertisement information, which is to be distributed, by executing the distribution advertisement deciding program 135 in the case where the search request is made to the book information database during the operation of the user terminal 1 is displayed, for example, on the advertisement display portion A6 of the search screen G5 (refer to FIG. 10).

Moreover, also in the case where the book information corresponding to the keyword specified by the user terminal 1 is searched from the DB 20 (book information database) (that is to say, in the case where the keyword is inputted to the search bar A4 of the search screen G5, and the start button B5 is operated (refer to FIG. 10)), the CPU 11 executes the distribution advertisement deciding program 135, and decides, as the advertisement information to be distributed, the optimal advertisement information based on the predetermined condition.

Here, with regard to the predetermined condition, advertisement information including the keyword is adapted to be decided as such advertisement information to be preferentially distributed. In such a way, the advertisement information including the keyword, namely, advertisement information related to the keyword is preferentially selected.

Note that the advertisement information decided as described above as the advertisement information, which is to be distributed, by executing the distribution advertisement deciding program 135 in the case where the book information corresponding to the keyword specified by the user terminal 1 is searched from the book information database is displayed, for example, on the advertisement display portion A8 of the search result screen G6 (refer to FIG. 11).

The CPU 11 executes such a distribution advertisement deciding program 135, and thereby functions as a distribution advertisement deciding unit.

The distributing program 136 is a program for allowing the CPU 11 to realize a function to distribute the advertisement information to the user terminal 1 in the case where the advertisement information concerned to be distributed is decided by the above-described distribution advertisement deciding program 135.

Specifically, when the book body screen G3, the search screen G5 and the search result screen G6 are displayed on the display screen 6 of the user terminal 1, the CPU 11 distributes the advertisement information decided by executing the above-described distribution advertisement deciding program 135, and allows the advertisement information to be displayed on these screens (the book body screen G3, the search screen G5 and the search result screen G6).

The CPU 11 executes such a distributing program 136, and thereby functions as a distributing unit.

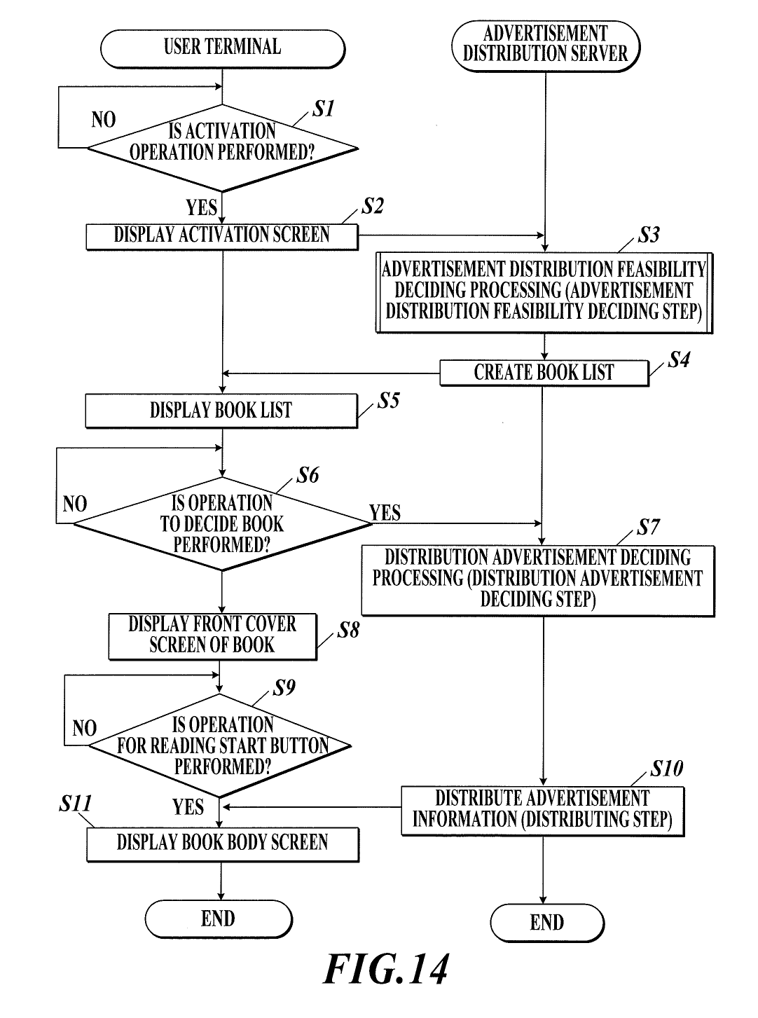

Next, a description is given for an advertisement distribution method of this embodiment with reference to FIGS. 14 to 16.

FIG. 14 shows a flowchart of advertisement distribution processing at the time when the user terminal 1 is activated.

The CPU 2 of the user terminal 1 determines whether or not an activation operation for the electronic book viewer 41 is performed by the user (Step S1), and repeats processing of Step S1 concerned in the case where the activation operation is not performed (Step S1: NO).

Meanwhile, when the activation operation is performed (Step 51: YES), the CPU 2 of the user terminal 1 displays the activation screen G1 (refer to FIG. 4) on the display screen 6, and accesses the advertisement distribution server 10 through the communication network N (Step S2).

Next, the CPU 11 of the advertisement distribution server 10 executes advertisement distribution feasibility deciding processing for deciding whether or not the advertisement is distributable to the user terminal 1 (Step S3: an advertisement distribution feasibility deciding step).

Next, the CPU 11 of the advertisement distribution server 10 creates the book list by using the book content information 21 and the purchase history information 27, and transmits the book list concerned to the user terminal 1 through the communication network N (Step S4).

Next, the CPU 2 of the user terminal 1 instructs the display screen 6 to display the book list (Step S5), determines whether or not the operation to decide the book to be read is performed by the user (Step S6), and repeats processing of Step S6 concerned in the case where the operation to decide the book is not performed (Step S6: NO).

Meanwhile, when the operation to decide the book is performed, the CPU 2 of the user terminal 1 accesses the advertisement distribution server 10 through the communication network N (Step S6: YES), and next, the CPU 11 of the advertisement distribution server 10 executes the distribution advertisement deciding processing for deciding the advertisement information 23, which is to be distributed to the user terminal 1, from among the advertisement information 23 stored in the DB 20 (Step S7: a distribution advertisement deciding step).

Next, the CPU 2 of the user terminal 1 instructs the display screen 6 to display the front cover screen G2 (refer to FIG. 5) of the book (Step S8), determines whether or not an operation for the reading start button B1 is performed (Step S9), and repeats processing of Step S9 concerned in the case where the operation for the reading start button B1 is not performed (Step S9: NO).

Meanwhile, when the operation for the reading start button B1 is performed, the CPU 2 of the user terminal 1 accesses the advertisement distribution server 10 through the communication network N (Step S9: YES), and the CPU 11 of the advertisement distribution server 10 distributes the advertisement information, in response (Step S10: a distributing step).

Next, the CPU 2 of the user terminal 1 instructs the display screen 6 to display the book body screen G3 (refer to FIG. 6) (Step S11).

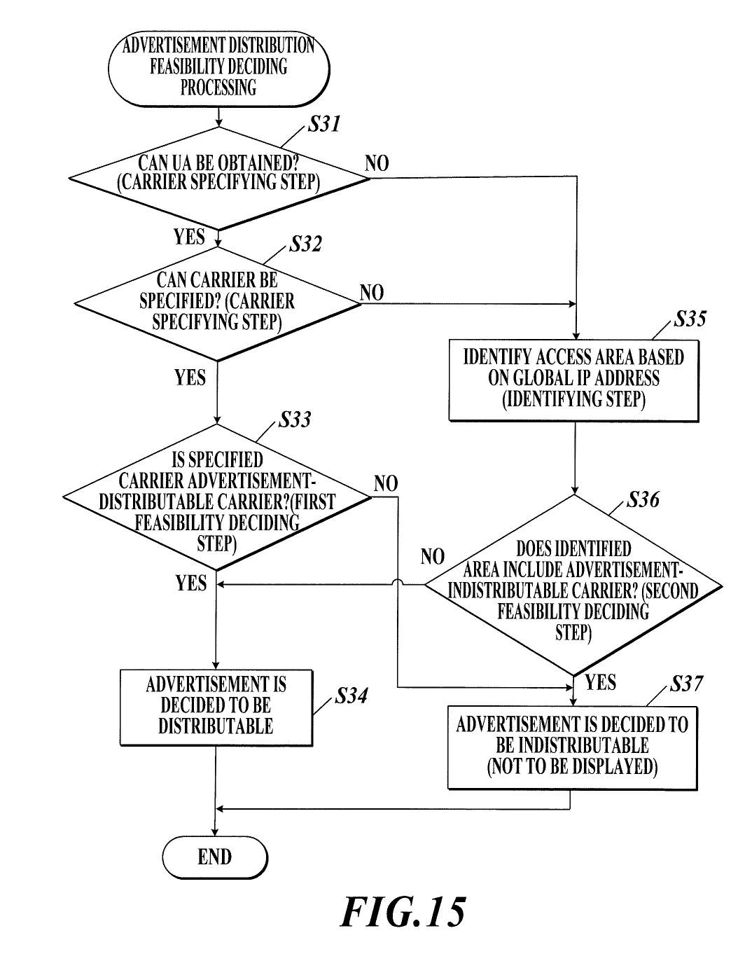

Here, FIG. 15 shows the advertisement distribution feasibility deciding processing of Step S3 described above.

First, the CPU 11 of the advertisement distribution server 10 determines whether or not the user agent (UA) can be obtained (Step S31: a carrier specifying step).

Then, in the case where the CPU 11 cannot obtain the UA (Step S31: NO), the CPU 11 proceeds to Step S35 to be described later, and meanwhile, in the case where the CPU 11 of the advertisement distribution server 10 can obtain the UA (Step S31: YES), the CPU 11 determines whether or not the carrier can be specified (Step S32: a carrier specifying step).

Then, in the case where the CPU 11 cannot specify the carrier (Step S32: NO), the CPU 11 proceeds to Step S35 to be described later, and meanwhile, in the case where the CPU 11 of the advertisement distribution server 10 can specify the carrier (Step S32: YES), the CPU 11 determines whether or not the specified carrier is the advertisement-distributable carrier (Step S33: a first feasibility deciding step).

Then, in the case where the specified carrier is determined to be the advertisement-distributable carrier (Step S33: YES), the CPU 11 of the advertisement distribution server 10 decides to distribute the advertisement thereto (that the advertisement is distributable) (Step S34), and in the case where the specified carrier is determined not to be the advertisement-distributable carrier (Step S33: NO), the CPU 11 decides not to distribute the advertisement thereto (that the advertisement is indistributable: not to be displayed) (Step S37).

Meanwhile, in the case where the CPU 11 of the advertisement distribution server 10 cannot obtain the UA (Step S31: NO), and in the case where the CPU 11 cannot specify the carrier (Step S32: NO), the CPU 11 identifies the access area by the global IP address (Step S35: an identifying step).

Next, the CPU 11 of the advertisement distribution server 10 determines whether or not the access area identified by Step S35 described above is the area in which the advertisement-indistributable carrier is included (Step S36: a second feasibility deciding step), and in the case where the identified access area is determined to be the area in which the advertisement-indistributable carrier is included (Step S36: YES), the CPU 11 decides not to distribute the advertisement thereto (Step S37).

Meanwhile, in the case where the identified area is determined not to be the area in which the advertisement-indistributable carrier is included (Step S36: NO), the CPU 11 decides to distribute the advertisement thereto (Step S34).

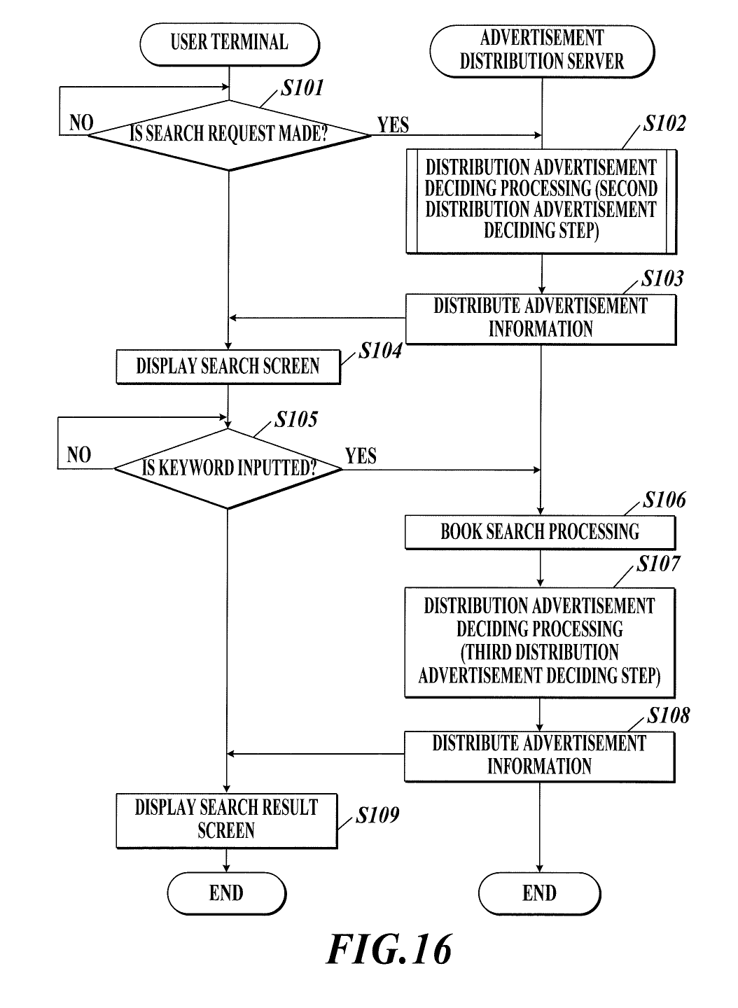

Next, FIG. 16 shows an advertisement distribution method in the case where the search is performed during the operation of the electronic viewer 41 of the user terminal 1.

The CPU 2 of the user terminal 1 determines whether or not a search request is made by the user (that is, the search button B3 is operated thereby) (Step S101), and repeats processing of Step S101 concerned in the case where the search request is not made (Step S101: NO).

Meanwhile, in the case where the search request is made, the CPU 2 of the user terminal 1 accesses the advertisement distribution server 10 through the communication network N (Step S101: YES).

Next, the CPU 11 of the advertisement distribution server 10 executes the distribution advertisement deciding processing for deciding the advertisement information, which is to be distributed to the user terminal 1, from among the advertisement information stored in the DB 20 (Step S102: a second distribution advertisement deciding step).

Next, the CPU 11 of the advertisement distribution server 10 distributes the advertisement information decided in Step S102 (Step S103: a distributing step).

Next, the CPU 2 of the user terminal 1 instructs the display screen 6 to display the search screen G5 (refer to FIG. 10) (Step S104), determines whether or not an input operation of the keyword to the search bar A4 of the search screen G5 is performed by the user (Step S105), and repeats processing of Step S105 concerned in the case where the input operation is not performed (Step S105: NO).

Meanwhile, in the case where the input operation of the keyword is performed, the CPU 2 of the user terminal 1 accesses the advertisement distribution server 10 through the communication network N (Step S105: YES), and next, the CPU 11 of the advertisement distribution server 10 executes book search processing for the book content information in the DB 20 (Step S106).

Next, the CPU 11 of the advertisement distribution server 10 executes the distribution advertisement deciding processing for deciding the advertisement information 23, which is to be distributed to the user terminal 1, from among the advertisement information 23 stored in the DB 20 (Step S107: a third distribution advertisement deciding step).

Next, the CPU 11 of the advertisement distribution server 10 distributes the advertisement information 23 (Step S108), and next, the CPU 2 of the user terminal 1 instructs the display screen 6 to display the search result screen G6 (refer to FIG. 11) (Step S109).

As described above, in accordance with the advertisement distribution server 10 and advertisement distribution method of this embodiment, it is decided whether or not the advertisement is distributable to the user terminal 1 based on the UA or the global IP address (user position information capable of specifying the access area), and thereby, the advertisement can be appropriately distributed according to the carrier and area of the user terminal 1.

Moreover, the advertisement information 23 submitted from the plurality of advertisement agencies is stored in the DB 20, and for the user terminal 1 to which the advertisement is decided to be distributable, the advertisement information 23 to be distributed thereto is decided from among the advertisement information 23 based on the predetermined condition. Accordingly, from among the advertisement information 23 from the plurality of advertisement agencies, the optimal advertisement information can be obtained, and can be then distributed.

In such a way, even if the electronic book viewer 41 on the user terminal 1 side is not changed, the advertisement distribution more accurate for the user can be performed.

Moreover, in accordance with the advertisement distribution server 10 and advertisement distribution method of this embodiment, the carrier is specified by the UA, and it is decided whether or not the advertisement is distributable based on the specified carrier. In addition, in the case where it is impossible to obtain the UA or to specify the carrier, the access area of the user terminal 1 is identified based on the global IP address, and it is decided whether or not the advertisement is distributable based on the identified access area. In such a way, even in the case where it is impossible to obtain the UA or to specify the carrier, the advertisement can be distributed to the user in the area in which the advertisement-indistributable carrier is not included, and accordingly, the number of users as subjects for the advertisement distribution can be increased, and an advertisement effect can be enhanced.

Moreover, in accordance with the advertisement distribution server 10 and advertisement distribution method of this embodiment, the application program is the electronic book viewer 41 that does not require a program update very frequently, and accordingly, it can be said that an effect of the invention of this application is more remarkable.

Furthermore, in accordance with the advertisement distribution server 10 and advertisement distribution method of this embodiment, the distribution advertisement deciding unit is configured to decide the advertisement information, which is to be distributed from the advertisement information storage unit 221 to the user terminal 1, based on the predetermined condition in the case where the search request is made to the book content information storage unit 21 by the user terminal 1 during the operation of the application program of the user terminal 1.

Therefore, an appropriate advertisement can be distributed at the time of displaying the search screen G5.

Moreover, in accordance with the advertisement distribution server 10 and advertisement distribution method of this embodiment, the distribution advertisement deciding unit is configured to decide the advertisement information, which is to be distributed from the advertisement information storage unit 221 to the user terminal 1, so that priority can be given to the advertisement information including the keyword specified by the user terminal 1 in terms of the predetermined condition in the case where the book information corresponding to the keyword concerned is searched from the book content information storage unit 21.

Therefore, the appropriate advertisement can be distributed at the time of displaying the search result screen G6.

Note that the configuration of the advertisement distribution server 10 is not limited to the contents of the above-described embodiment, and is appropriately modifiable within the scope without departing from the spirit of the present invention.

For example, it is also possible to compose the advertisement distribution server 10 of a plurality of servers.

Specifically, in the above embodiment, the description has been made of the advertisement distribution server 10 while taking as an example the configuration in which the functions of the content (electronic book) distribution server and the advertisement distribution server are provided in one server; however, for example, a configuration composed of two separate servers, which are the content distribution server and the advertisement distribution server, may also be adopted.

Moreover, in this embodiment, the description has been made of the user terminal while taking the electronic book device as an example; however, besides this, the user terminal may be, for example, a cellular phone, a notebook-type personal computer, a personal digital assistant (PDA), and the like.

Furthermore, the description has been made of the user position information while taking the global IP address as an example; however, besides this, the user position information may be, for example, access point information and GPS information of the cellular phone. In this case, the area ID is assigned for each region narrower than a country.

The present invention is applicable to the information communication field, and the like.

Although the invention above has been described in connection with preferred embodiments of the invention, it will be evident for a person skilled in the art that several modifications are conceivable without departing from the invention as defined by the following claims.

What is claimed is:

1-19. (canceled)

10. An advertisement distribution server which distributes advertisement information to a user terminal including an application program capable of displaying the advertisement information, the advertisement distribution server being connected to the user terminal through a communication network, the advertisement distribution server comprising:
an advertisement information database to store the advertisement information;
an advertisement distribution feasibility deciding unit to decide whether or not an advertisement is distributable to the user terminal, based on a user agent obtained from the user terminal or on user position information capable of specifying an access area of the user terminal, when the application program of the user terminal is activated;
a distribution advertisement deciding unit to decide the advertisement information to be distributed from the advertisement information database to the user terminal, based on a predetermined condition, in a case where the advertisement is decided to be distributable by the advertisement distribution feasibility deciding unit; and
a distributing unit to distribute the advertisement information to the user terminal, in a case where the advertisement information to be distributed is decided by the distribution advertisement deciding unit, wherein
the advertisement distribution feasibility deciding unit includes:
a carrier specifying unit to obtain the user agent from the user terminal when the application program of the user terminal is activated, so as to specify a carrier of the user terminal;
a first feasibility deciding unit to decide whether or not the advertisement is distributable, based on the carrier specified by the carrier specifying unit;
an identifying unit to identify the access area of the user terminal, based on a global internet protocol (IP) address as the user position information, in a case where the user agent cannot be obtained or the carrier cannot be specified by the carrier specifying unit; and
a second feasibility deciding unit to decide whether or not the advertisement is distributable, based on the access area identified by the identifying unit.

11. The advertisement distribution server according to claim 10, wherein the application program is an electronic book viewer.

12. The advertisement distribution server according to claim 10, further comprising:
a book information database to store book information, wherein
the distribution advertisement deciding unit decides the advertisement information to be distributed from the advertisement information database to the user terminal, based on the predetermined condition, in a case where a search request is made to the book information database by the user terminal during an operation of the application program of the user terminal.

13. The advertisement distribution server according to claim 12, wherein
in a case where book information corresponding to a keyword specified by the user terminal is searched from the book information database, the distribution advertisement deciding unit decides the advertisement information to be distributed from the advertisement information database to the user terminal, so that priority is given to advertisement information including the keyword, as the predetermined condition.

14. An advertisement distribution method to distribute advertisement information from the advertisement distribution server according to claim 10 to the user terminal including the application program capable of displaying the advertisement information, the advertisement distribution server being connected to the user terminal through the communication network, the advertisement distribution method comprising:
an advertisement distribution feasibility deciding step of deciding whether or not the advertisement is distributable to the user terminal, based on the user agent obtained from the user terminal or on the user position information capable of specifying the access area of the user terminal, when the application program of the user terminal is activated;
a distribution advertisement deciding step of deciding the advertisement information to be distributed from the advertisement information database to the user terminal, based on the predetermined condition, in the case where the advertisement is decided to be distributable in the advertisement distribution feasibility deciding step; and
a distributing step of distributing the advertisement information to the user terminal, in the case where the advertisement information to be distributed is decided in the distribution advertisement deciding step, wherein
the advertisement distribution feasibility deciding step includes:
a carrier specifying step of obtaining the user agent from the user terminal when the application program of the user terminal is activated, and of specifying the carrier of the user terminal;
a first feasibility deciding step of deciding whether or not the advertisement is distributable, based on the carrier specified in the carrier specifying step;
an identifying step of identifying the access area of the user terminal, based on the global IP address as the user position information, in the case where the user agent cannot be obtained or the carrier cannot be specified in the carrier specifying step; and
a second feasibility deciding step of deciding whether or not the advertisement is distributable, based on the access area identified in the identifying step.

15. The advertisement distribution method according to claim 14, further comprising:
a second distribution advertisement deciding step of deciding the advertisement information to be distributed from the advertisement information database to the user terminal, based on the predetermined condition, in the case where the search request for the keyword is made by the user terminal during the operation of the application program of the user terminal.

16. The advertisement distribution method according to claim 15, further comprising:
a third distribution advertisement deciding step of deciding the advertisement information to be distributed from the advertisement information database to the user terminal, so that priority is given to the advertisement information including the keyword specified by the user terminal, as the predetermined condition, in the case where the book information corresponding to the keyword is searched from the book information database.
